(19) United States
(12) Patent Application Publication
(10) Pub. No.: US 2017/0076287 A1
(43) Pub. Date: Mar. 16, 2017

(54) Electronic payment system with option to accept or reject a proffered payment

(71) Applicant: Edward N Hall, Winter Garden, FL (US)

(72) Inventor: Edward N Hall, Winter Garden, FL (US)

(21) Appl. No.: 14/854,465

(22) Filed: Sep. 15, 2015

(51) Int. Cl. G06Q 20/40

(52) U.S. Cl. CPC G06Q 20/405

(57) ABSTRACT

A system and method for selective processing of electronic payments such as rent or utility bill payments is disclosed. Payer tenders an electronic payment through a web-based user interface and a notice is transmitted to Payee that funds are available for transfer if Payee chooses to accept the payment. Payee has the opportunity to review the details of the incoming payment and can choose to accept the payment, in which case, funds are transferred to Payee, or reject it, in which case the transfer of the funds is cancelled and no payment is made to the Payee.

### FIELD OF THE INVENTION

This invention is in the field of electronic payment processing through Internet or network-based interfaces with the participants and a payment clearing service.

### BACKGROUND OF THE INVENTION

Internet-based online payment for goods or services, or payments of a variety of obligations, is common at the present time. For example, an individual may go to a website maintained by the USPTO, fill in an electronic form, select a payment method, such as a credit card or debit card, enter the appropriate authorizing information, and click “Submit.” Funds are then transferred and an electronic receipt is displayed, and a receipt is transmitted to the customer. Convenience to the customer and provider is manifest: an immediate payment and receipt are generated without the need of the customer to travel to a service center maintained by the USPTO; moreover, these transactions may be processed 24 hours a day, 7 days a week.

In the above instance, the immediate transfer of money creates an obligation on the part of the USPTO to perform a specific act, whether it is to process a trademark application or to review a patent application. It is this reliable and secure transfer of funds that is the foundation of electronic commerce and the orderly exchange of goods and services.

The property management industry, made up of building owners that rent residential or commercial real estate to Payers, can also benefit from the convenience and accuracy of a web-based system for payment and collection of rent. While some Payees collect rent directly from Payers, many large volume building owners depend upon property manager agents to administer the collection of rents and eviction of non-paying tenants, among other duties. Similarly, utility service providers such as water, electricity and waste collection can benefit from the electronic presentation of bills and the ensuing accelerated payment of outstanding bills.

One characteristic of the Payee-Payer relationship that separates the property management industry from many others is that acceptance by the Payee of a Payer's rent payment may convey substantive rights to a Payer with respect to the leased premises. The relationship is governed by state laws. In some states, acceptance of even a small partial payment engenders a cure period wherein the Payer has a set number of days to make the balance of the factually overdue rent payment, automatically waives any penalties and reinstates the Payer relationship to ‘in good standing’. Residential Payee-Payer statutes in many states, drafted to protect Payers from evictions, offer a variety of Payer rights stemming from the making of part payment for current or overdue past rent.

Utility service providers face similar issues when dealing with customers whose payments are overdue and have been informed that their service will be cut-off unless full payment including late fees or other charges are received by a set time and date.

As electronic payments have become pervasive and almost universal, there has arisen a need for an alternate payment methodology which recognizes the needs of other businesses and entities who wish to participate in electronic commerce but whose business methodology or policies or governmental regulations restrict this ability. Because of the possibility of substantive Payer rights upon the Payee's acceptance of a payment, the examples cited above and numerous others where the Payee may incur certain obligations on account of accepting funds from a Payer, are not well served by a web-based payment system that automatically transfers the tendered funds. It would be useful to have a system whereby Payee or his agent has the ability to reject a payment if the amount is incorrect or its acceptance could establish rights adverse to the Payee's interests.

Conventional payment systems in which the Payer entrusts a payment processing service to automatically deliver their payment to the Payee can easily create adverse and inadvertent obligations on the part of the Payee who may have unknowingly received a payment without having had the opportunity to decide if they want to, in fact, accept the payment.

The alternative payment method described in this application is typically described to potential users as the ‘accept or reject’ method. This name has become so entwined with this method that the applicant has filed an application to register the trademark since the words alone convey the method and the opportunity for use.

The applicant restricts its payment processing business to companies in markets which require or can use the ‘accept or reject’ method. In a recent example, a very large title and escrow company sought out the applicant to license the ‘accept or reject’ payment method to enable its customers; home purchasers, to make initial escrow deposits as part of their purchase transaction. The company had previously attempted to create its own escrow deposit system which failed to meet company and state regulations which require the company to be in possession of a signed ‘escrow’ agreement before accepting funds into its trust account and instead turned to the applicant since in its words “we've looked everywhere, and you guys are the only game in town’.

The above statement recognizes a very important point: the methodology and technology which is the subject of this application is not intuitive or easily re-created, since if it were, there would be numerous other companies offering this payment methodology and in our ten year experience in payment processing, we have not ever encountered a competitor offering a similar payment method.

### SUMMARY OF THE PRESENT INVENTION

The present invention is a network or web-based payment processing system particularly useful for Payees whose rights or obligations might be adversely affected if a Payer's payment is automatically deposited to their account. The Payer logs into the system and makes a payment in much the same way he would pay other bills online. Simultaneously, the Payee is sent an email message that a payment is being offered. The Payee or his agent logs in at a convenient time and reviews the proffered payment and if he elects to accept the payment, the transfer of funds is then initiated in much the same way as a conventional electronic payment is made and the funds are deposited to the Payee's account and a notice of acceptance is transmitted to the Payer. Any deficient payments may be rejected with a mouse click, and the manager may add a comment explaining the rejection. When a payment is rejected, a message advising of the rejection is transmitted to the Payer.

The key element that distinguishes this payment process from conventional payment services is that this payment service acts as an agent of the Payer and offers the payment to the Payee for their acceptance rather than acting as the agent of the Payee and automatically accepting the payment. Such a method gives full control over the payment process to the Payee.

### BRIEF DESCRIPTION OF THE DRAWINGS

FIG. 1 is a block diagram of the principal components of the payment system.

FIG. 2 is a flow diagram showing the operation of the payment system.

### DETAILED DESCRIPTION OF THE INVENTION

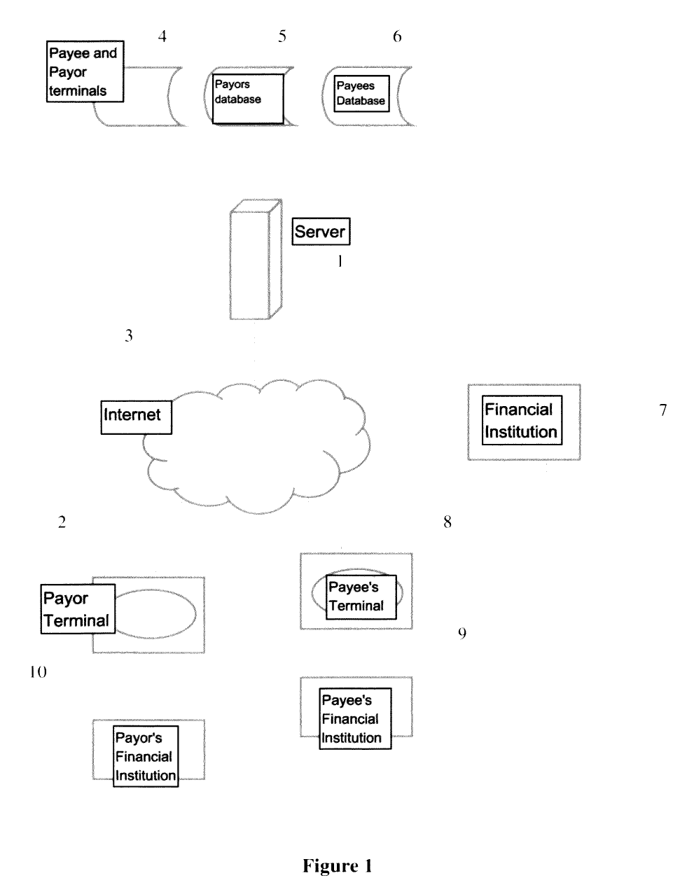

The physical components of one embodiment of the system are shown schematically in FIG. 1. The primary software and records database is located at server 1. The system may be configured with multiple servers in different locations, interconnected and sharing databases as necessary.

Server 1 includes an interface for use by Payers who will make payments. Payers communicate with server 1 through their terminals 2 via the Internet 3. The Payer terminal could be a personal computer, a wireless handheld input device, or any device capable of electronic communication with server 1. In a preferred embodiment, the Payer terminal only needs standard web browser software to communicate with the server

Server 1 contains database of Payer customers and Payee merchants 4, interface software for Payers 5 and interface software for Payees 6. Server 1 may also contain transaction processing software capable of interconnecting with financial institutions used by Payers and withdrawing funds as authorized by Payers. In the displayed embodiment, however, software on server 1 communicates via the Internet 3 with a transaction processing server of a financial institution 7. The processing service communicates directly with the institutions 10 holding funds of Payers and effects and tracks the movement of funds into the system and then to the Payee's financial institution 9.

Payee merchants are connected to server 1 via the Internet 3 through Payee terminals 8, which may be browser-enabled personal computers or other devices. The operation of the system is described below.

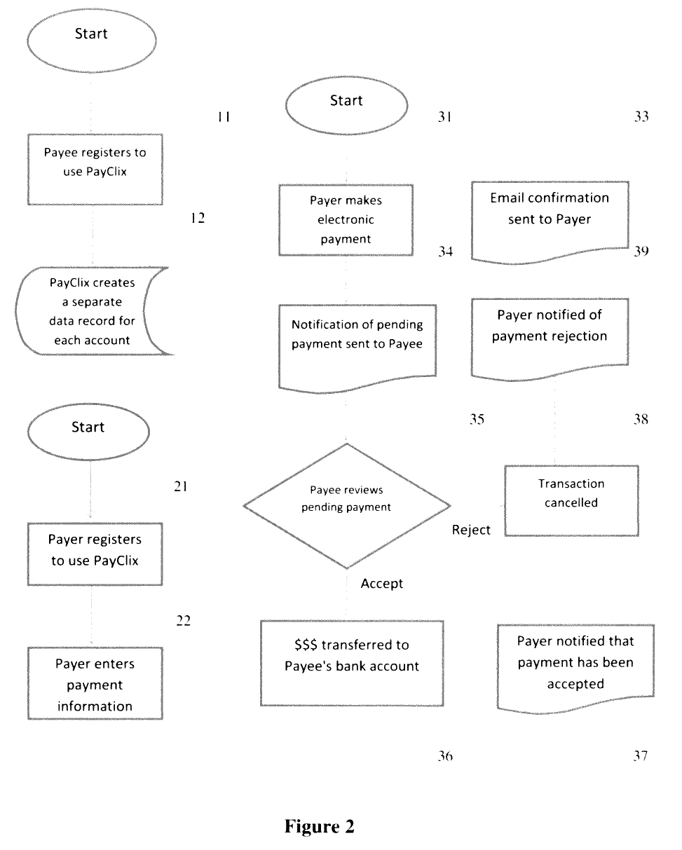

Operation of the system is illustrated in one embodiment in FIG. 2. In this embodiment a Payer makes a payment to a Payee through a payment processing software system residing on server 1. As noted above, funds transfers could alternatively be handled by a server at a financial institution.

The Payee registers an account with the Payee and any accounts to be included in the payment processing system 11 and in the course of doing so creates a unique user name with an accompanying password for future system access. Data entry includes contact personnel, email addresses, bank account information, payment acceptance policies, late fees, and other information for each Payee account 12.

A Payer registering with the system creates a unique user name and password. Payer also adds information identifying the account to be credited, the Payee's identity, and the financial institution through which Payer will be making payments 22. Payer may have option of registering for an ‘automatic payment’ option whereby the system will automatically debit their bank account or credit card on a predetermined day each month.

One of the terms of registration that must be agreed to by Payer upon registration, is that the Payer appoints the system operator as his agent for notifying Payee that the Payer wishes to submit a payment and to transmit to the Payee the payment amount if the payment is accepted by the Payee. Payer may also be advised that payments will incur a convenience fee, which will be added to the amount that they authorize be debited to their account.

When the Payer decides to use the system, the Payer logs in and completes an electronic form to make an electronic payment using the system software 31. Payment may be made using credit card, debit card or via an electronic check (ACH).

When the Payer approves the payment, the software initiates the transfer of funds via an Internet transaction. Funds remain in the Payer's account until a decision is made by the Payee to accept or reject the proffered payment. If the Payer's financial institution denies an authorization, the Payer is informed, the transaction fails and no transfer of funds occurs. If the Payer pays by credit card, the software may communicate with the credit card processor to reserve or hold available the funds until demanded at a later step in the process.

If the credit card or bank debit transaction is authorized by the Payer's financial institution, the Payer receives an immediate confirmation of payment received 33 via email, conditional upon acceptable of the payment by the Payee and sufficient funds being available in the Payer's account.

The Payee or his designated agent receives an email notice that Payer has proffered a payment 34. The Payee then decides whether or not to accept the proffered payment. This is done by following a link provided in the notification email and signing into the system by supplying the unique user name and password. The Payee is then presented with a web form listing current ‘Pending Payments’ for each account managed. For each pending payment, the Payee selects, by clicking on a ‘radio button’, his decision to Accept or Reject the pending payment. A ‘radio button’ is a common web form data control. It has only an ‘on’ or ‘off’ state and when multiple options are available, e.g., ‘Accept’ or ‘Reject,’ allows only one option to be chosen.

When the choice is made to either ‘Accept’ or ‘Reject’, the software then follows the appropriate logic path as set out below. It is to be expected that there will be a delay in the period between the time a Payer authorizes a payment and the payment is evaluated for acceptance by the Payee. The Payee, when registering to use the system, contractually agrees that the ‘payment date’ will be the date the Payer submits the payment and not the date the Payee accepts the payment. Thus, a payment made at 11:59 PM on the last day for accepting rents before the due date would not be considered to be late even if the Payee did not make a decision to accept the payment until several days later. This reconciles customary industry practice, where a rent payment is not actually ‘made’ until it is accepted by the Payee, with a system in which the Payee does not wish to deal immediately with a payment the instant it is tendered, but will give retroactive credit to properly tendered payments. The software may, for example, contain numerous edits and warning to alert users of unusual conditions, e.g., a pending payment still outstanding four days after it was proffered.

If the payment is accepted, Payer's funds are transferred automatically and electronically into the Payee's account 36. If a credit card amount was reserved, the funds may be transferred from the credit card's sponsoring institution. The Payer is notified that payment was accepted 37. At the same time, a payment processing fee agreed to by the Payee is transferred to the operator's bank account.

If the payment is rejected, the transaction is canceled and no funds are transferred to the Payee 38 and the Payee may write a reason for the rejection 39. It is then the Payer's obligation to contact the Payee and work out a non-electronic payment scheme to the obligation or make a new submission with the required payment amount.

Regardless of their decision, the Payee may be given an opportunity to add comments to the decision email before it is sent to the Payer.

The Payee may have access to numerous reports which aid in managing their business. These reports include listings of previously accepted payments, rejected payments and pending payments. Reports may be ordered by the user in various sort sequences with appropriate arithmetic totals and sub-totals. The disclosed invention is not limited to the example given above. Indeed, the claimed methodology can be applied to virtually all other electronic payment systems where a payment is proffered under the terms of an agreement or contract. The software may also include a rules-based decision matrix, the decision parameters of which can be controlled interactively by the recipient, which would automate the acceptable or rejection of payments without manual intervention.

The claimed methods of this invention may substantially reduce the payment processing difficulties faced by companies who receive periodic payments where the Payee can make a payment at an amount lower that is contractually required, the acceptance of which then binds the recipient to certain legal obligations which can be restrictive or undesired.

1. A method for transferring electronic payments from a Payer to a Payee, comprising the steps of:
Receiving into an electronic payment system a request for an electronic payment from a Payer to a designated Payee;
Querying the Payee whether to accept or reject the payment; and
Sending funds to an account designated by the Payee if Payee accepts said payment, or cancelling the transaction if Payee rejects said payment.

2. The method of claim 1 further comprising sending notification and details to a Payer when payments are rejects by Payee.

3. The method of claim 1 further comprising sending notification to a Payee when a payment is received from a Payer.

4. The method of claim 1 further comprising sending notification to a Payer when payments are accepted by Payee.

5. The method of claim 1 wherein said payment is of the type selected from the group consisting of credit card, debit card, or an electronic check

6. The method of claim 1 wherein said Payer is charged a convenience fee for using said electronic payment system, payable to the operators of said electronic payment system.

7. The method of claim 1 wherein said Payee is charged a processing fee for using said electronic payment system, payable to the operators of said electronic payment system.

8. The method of claim 1 further comprising sending notification to the Payee when a payment is received from the Payer, and sending notification and details to the Payer when payments are accepted or rejected by the Payee.
